(19) United States
(12) Patent Application Publication
(10) Pub. No.: US 2014/0196609 A1
(43) Pub. Date: Jul. 17, 2014

(54) PIZZA OVEN ACCESSORY FOR A BARBECUE

(71) Applicant: Anton Snyman, Durbanville (ZA)

(72) Inventor: Anton Snyman, Durbanville (ZA)

(21) Appl. No.: 14/118,550

(22) PCT Filed: May 16, 2012
(86) PCT No.: PCT/ZA12/00033

§ 371 Date: Feb. 10, 2014

(30) Foreign Application Priority Data
May 19, 2011 (ZA) 2011/03655

(51) Int. Cl. A47J 37/07

(52) U.S. Cl. CPC A47J 37/0786
USPC 99/340

(57) ABSTRACT

This invention relates to a pizza oven accessory (10) for a barbecue. More specifically, the invention relates to a pizza oven accessory (10) for converting a kettle-type barbecue into a pizza oven. The pizza oven accessory (10) includes a hollow body (12) and a food receiving member (14). The hollow body (12) is receivable between a fuel receiving base (100) and a lid (102) of a barbecue so as to define in use a cooking chamber (22) within the hollow body (12) and between the base (100) and lid (102) of the barbecue. The hollow body (12) further defines an access opening (24) through which food is introducible or removable from the cooking chamber (22). The food receiving member (14) on which the food is receivable, is rotatably supported within or in close proximity with the hollow body (12).

### BACKGROUND OF THE INVENTION

THIS invention relates to a pizza oven accessory for a barbecue. More specifically, the invention relates to a pizza oven accessory for converting a kettle-type barbecue into a pizza oven.

Accessories for converting existing types of cooking apparatus into alternative ones are known. One known type of accessory is a rotisserie insert supportable on a base of a conventional barbecue. The rotisserie insert is typically made up of a tubular body adapted to receive a rotating skewer therein on which food to be cooked is receivable. Skewered food is placed into the rotisserie insert through an upper open end with no need for a lid or an access opening in a side wall of the rotisserie insert. It will be appreciated that for the purposes of cooking pizza, a lid is essential to keep the heat within the barbecue. As such, an access opening in a side wall through which a pizza can be introduced and removed from the barbecue is essential for a pizza oven type insert.

Another known type of accessory is a smoker insert receivable between the base and lid of a conventional barbecue for converting the conventional barbecue into a smoker. The smoker insert is typically in the form of a tubular body having one or more formations therein to support a food receiving grill. Some smoker inserts also define closable openings in the side wall. Although much more suitable to the cooking of a pizza, the openings defined by the smoker inserts are typically positioned below a surface on which the food is receivable and used generally to add further fuel to the barbecue.

Yet another known type of accessory is the KettlePizza Oven which is a pizza oven insert receivable between the base and lid of a conventional barbecue for converting the conventional barbecue into a pizza oven. The KettlePizza Oven comprises a tubular body and an access opening therein through which a pizza may be introduced into the pizza oven. A disadvantage of the KettlePizza Oven is that the pizza is supported on the original grill of the conventional barbecue, preventing the pizza from being easily rotated during cooking to ensure that the pizza is evenly cooked. Another disadvantage of KettlePizza Oven is the fact that the insert does not fit the plate profiles of the standard 570 mm kettle and its lid. The result of this is that valuable heat escapes during the baking cycle.

Accordingly, it is an object of the present invention to provide a pizza oven accessory for barbecues that addresses the disadvantages of the known prior art.

### SUMMARY OF THE INVENTION

According to the invention there is provided a pizza oven accessory for a barbecue including:
a hollow body receivable between a fuel receiving base and a lid of the barbecue so as to define in use a cooking chamber within the hollow body and between the base and lid of the barbecue, the hollow body further defining an access opening through which food is introducible or removable from the cooking chamber; and
a food receiving member on which the food is receivable, the food receiving member being rotatably supported within or in close proximity with the hollow body.

Typically, the hollow body includes a lower end supportable on the fuel receiving base of the barbecue, an upper end on which the lid of the barbecue is supportable and a side wall(s) extending between the lower and upper ends in which the access opening is defined. Preferably, the barbecue is a kettle-type barbecue and the hollow body is tubular in shape. More preferably, the pizza oven accessory further includes one or more handles extending outwardly from the side wall(s) of the hollow body.

Generally, the food receiving member is rotatably supported on a support member at or near the lower end of the hollow body such that the food receiving member is rotatable relative to the hollow body. The food receiving member may be rotatably supported offset from a central axis extending through the lower and upper ends of the hollow body such that the food receiving member is located within the hollow body nearer the side wall or portion thereof defining the access opening than to the opposite side wall or portion thereof. Preferably, the upper surface of the food receiving member may be aligned with a bottom edge of the access opening defined in the hollow body. More preferably, the food receiving member is round in shape.

In a particularly preferred embodiment, the food receiving member is a pizza stone, with the pizza stone being rotatable on a rotating wheel rotatably mounted on the support member, thereby enabling in use the food to be rotated during cooking so as to cook the food evenly.

Furthermore, the pizza oven accessory includes a guard mounted on the support member and within the hollow body for preventing food introduced in use into the pizza oven from falling off the food receiving member. Preferably, the guard extends higher than the upper surface of the food receiving member, runs closely along at least a portion of a periphery of the food receiving member and is located in the hollow body nearer the side wall or portion thereof opposite the side wall or portion thereof defining the access opening.

The support member may be supportable within the hollow body on corresponding support formations located within the hollow body. Alternatively, the support member is fastenable to the hollow body. In yet another alternative embodiment, the support member is fixed to the hollow body.

Preferably, the food is pizza. It will be appreciated however that the pizza oven accessory may be used for any number of other oven-baked foods including bread, meat, fish and various other foods.

According to a second aspect of the invention, there is provided a barbecue including a fuel receiving base, a lid and a pizza oven accessory as herein described.

### BRIEF DESCRIPTION OF THE DRAWINGS

The invention will now be described in more detail, by way of example only, with reference to the accompanying drawings in which:

FIG. 1 shows an exploded perspective view of a pizza oven accessory for a barbecue in accordance with the present invention;

FIG. 2 shows a perspective view of an assembled pizza oven accessory relative to a barbecue on which the pizza oven accessory is receivable;

FIG. 3 shows a top view of the assembled pizza oven accessory of FIG. 2;

FIG. 4 shows a perspective view of the assembled pizza oven accessory supported on a fuel receiving base of the barbecue; and

FIG. 5 shows a perspective view of the assembled pizza oven accessory received between the fuel receiving base and a lid of the barbecue.

### DETAILED DESCRIPTION OF THE DRAWINGS

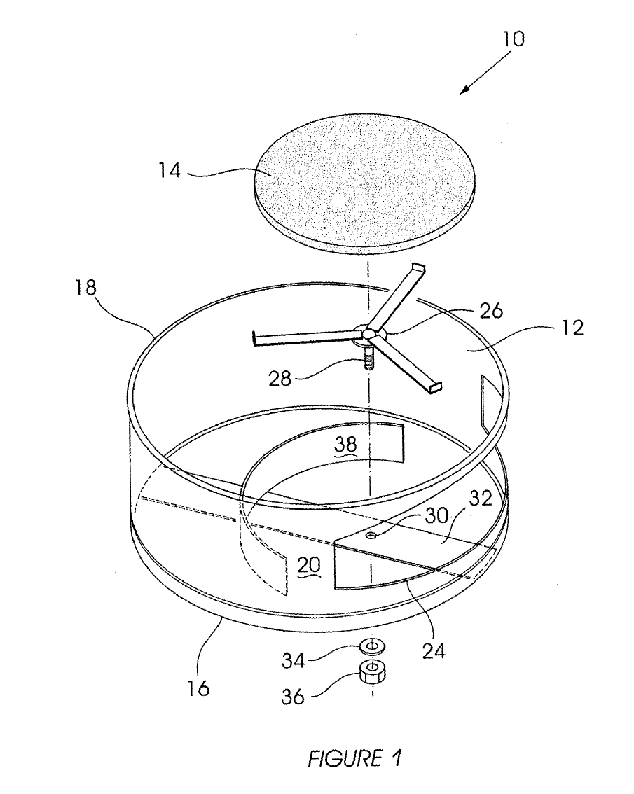

A pizza oven accessory for a barbecue according to a preferred embodiment of the invention is designated generally with the reference numeral 10 in FIG. 1. The pizza oven accessory comprises a hollow body 12 and a food receiving member 14 rotatably mounted within or in close proximity with the hollow body 12.

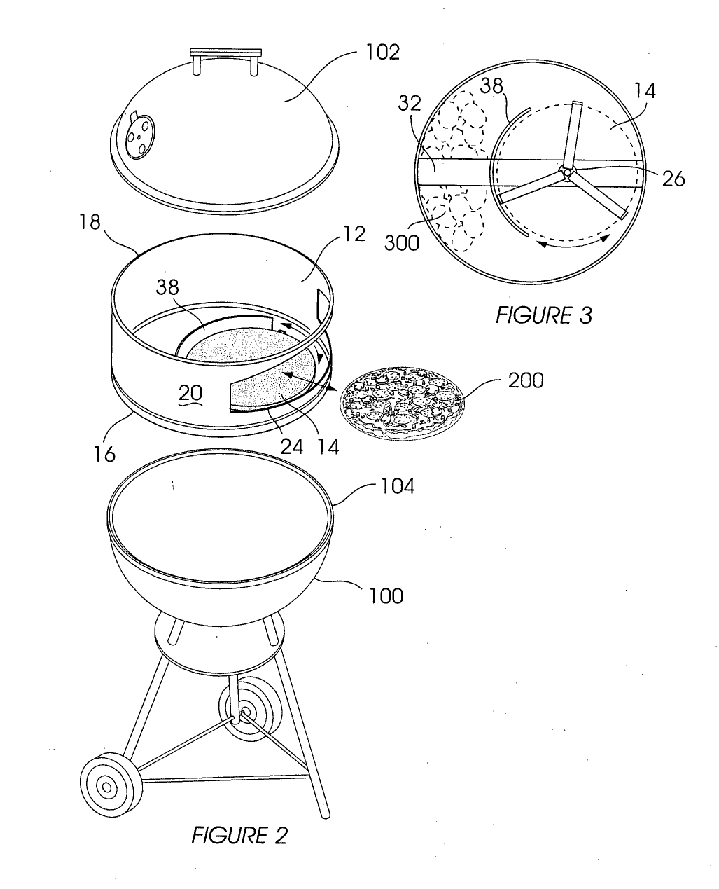

Although the pizza oven accessory 10 may be applied to any type of barbecue, the invention will be described with reference to a kettle type barbecue having a substantially hemispherical fuel receiving base 100 and a substantially hemispherical lid 102 as illustrated in FIG. 2. With reference to FIG. 1 and FIG. 2, the hollow body 12 is tubular in shape having a lower end 16, an upper end 18 and a side wall 20 extending between the lower and upper ends 16,18.

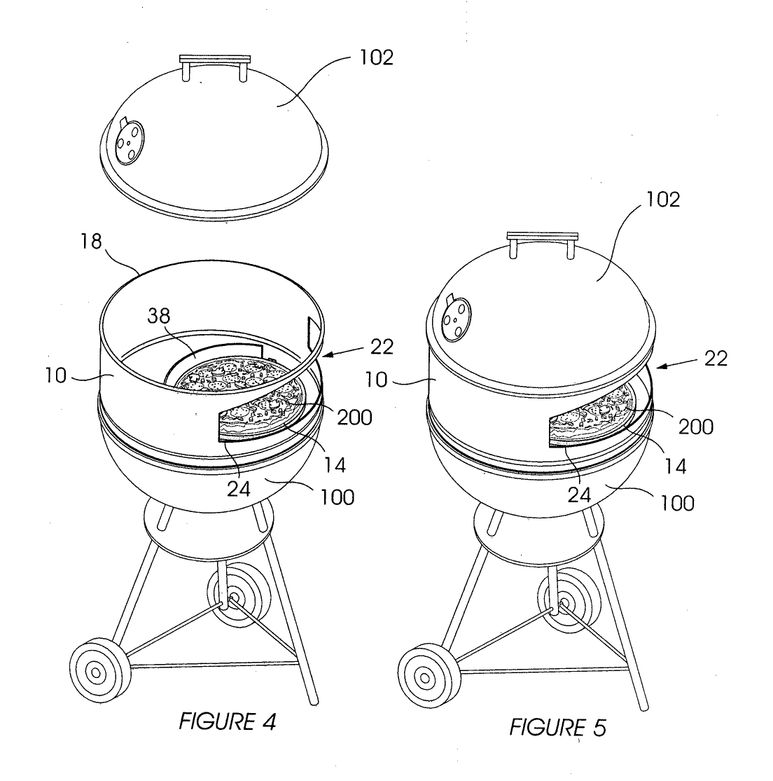

With reference specifically to FIG. 2 and FIG. 4, the lower end 16 of the tubular body 12 is adapted to rest on an upper rim 104 of the fuel receiving base 100 of the barbecue, with the upper end 18 of the pizza oven accessory adapted to receive the lid 102 of the barbecue as illustrated in FIG. 5. In this manner, the pizza oven accessory 10 is receivable between the fuel receiving base 100 and the lid 102 of the barbecue so as to define a cooking chamber 22 within the tubular body 12 and between the fuel receiving base 100 and the lid 102 of the barbecue. It will be appreciated that the tubular body 12 is shaped and sized to fit snugly between the receiving base 100 and the lid 102 of the barbecue so as to retain as much heat within the barbecue and cooking chamber 22 as possible.

Referring now to FIG. 1 and FIG. 2, the tubular body 12 of the pizza oven accessory 10 defines an access opening 24 through which a pizza 200, or any other type of food, is introducible and/or removable from the cooking chamber 22. With specific reference to FIG. 1 and FIG. 3, the food receiving member 14 is preferably a round pizza stone supported on a rotating wheel 26 having a threaded shank 28 extending downwardly from the rotating wheel 26. The threaded shank 28 of the rotating wheel 26 is receivable in an aperture 30 defined in a support member 32 extending across the lower end 16 of the tubular body 12.

The rotating wheel 26 is rotatably secured to the support member 32 by a washer 34 and a nut 36 tightened to the threaded shank 28 on an underside of the support member 32. It will be appreciated that although the support member 32 is shown as being welded to the tubular body 12, it may be fixed thereto other fastening means or supported therein by corresponding support formations on the tubular body 12 and the support bar 32. It will be appreciated that the pizza stone 14 is illustrated in broken lines in FIG. 3 to show the workings of the rotating arm 26 with the support bar 32.

Preferably, the aperture 30 on the support member 32 is not located on a central axis extending through the lower and upper ends 16, 18 of the tubular body 12, such that the pizza stone 14 is offset from the centre and positioned closer to the access opening side of the tubular body 12 than to a the opposite side thereof. The offset position of the pizza stone 14 enables easy introduction and removable of the pizza 200 to and from the pizza stone 14. The ease of introduction and removable of the pizza 200 is further enabled by the alignment of an upper surface of the pizza stone 14 with a lower edge of the access opening 24. The offset position of the pizza stone 14 serves another very important purpose, similar to that of a convection oven, in that the heat of the flames moves operatively upwardly through gaps defined between the pizza stone 14 and the sidewall 20 of the hollow body 12, so as to pass over the top of the pizza and bake the toppings thereon.

To prevent the pizza 200 from slipping off the pizza stone and into the fuel receiving base 100 of the barbecue, a guard 38 is mounted to the support bar 32. The guard 38 extends higher than the upper surface of the pizza stone 14, runs closely along at least a portion of a periphery of the pizza stone 14 and is located in the tubular body 12 nearer the side opposite the side wall defining the access opening 24.

In use, and with reference specifically to FIGS. 3, 4 and 5, the pizza oven accessory 10 is mounted between the fuel receiving base 100 and the lid 102 of the barbecue to form a pizza oven. Burning fuel 300, for example charcoal and/or wood, is positioned in the fuel receiving base 100 of the barbecue so as to tie under the annular space defined between the guard 38 and the side of the tubular body 12 opposite to the side wall in which the access opening 24 is defined. This enables heat from the burning fuel to correctly heat the pizza stone 14 and pass upwardly into the cooking chamber 22 to cook the top of the pizza 200.

When the correct temperature has been obtained, the pizza 200 is introduced into the cooking chamber 22 of the pizza oven accessory 10 and rested on the pizza stone 14. The ability of the pizza stone 14 to rotate relative to the tubular body 12 enables the pizza 200 to be rotated during cooking ensuring that the pizza 200 is evenly cooked. Once cooked, the pizza 200 is removed from the pizza oven accessory 10 via the access opening 24.

Although the invention has been described above with reference to preferred embodiments and examples, it will be appreciated that many modifications or variations of the invention are possible without departing from the spirit or scope of the invention. For example, the pizza oven accessory 10 may include one or more handles extending outwardly from the side wall 20 of the tubular body 12. In another example, the food receiving member 14 is mounted within the radial limits of the side wall 20 of the hollow body 12, but passed the axial limits of the lower end 16 or the upper end 18 thereof. In yet another example, the pizza stone 14 can be replaced by any number of food receiving member, such as a hot rock or a frying pan.

1. A pizza oven accessory for a barbecue including:
a hollow body receivable between a fuel receiving base and a lid of the barbecue operable to define a cooking chamber within the hollow body and between the base and lid of the barbecue, the hollow body further defining an access opening through which food is introducible or removable from the cooking chamber; and
a food receiving member on which the food is receivable, the food receiving member being rotatably supported within or in close proximity with the hollow body.

2. The pizza oven accessory according to claim 1, wherein the hollow body includes a lower end supportable on the fuel receiving base of the barbecue, an upper end on which the lid of the barbecue is supportable and one or more side walls extending between the lower and upper ends in which the access opening is defined.

3. The pizza oven accessory according to claim 1, wherein the barbecue is a kettle-type barbecue and the hollow body is tubular in shape.

4. The pizza oven accessory according to claim 1, wherein the hollow body includes a lower end supportable on the fuel receiving base of the barbecue, an upper end on which the lid of the barbecue is supportable and one or more side walls extending between the lower and upper ends in which the access opening is defined, further including one or more handles extending outwardly from the one or more side walls of the hollow body.

5. The pizza oven accessory according to claim 1, wherein the hollow body includes a lower end supportable on the fuel receiving base of the barbecue, an upper end on which the lid of the barbecue is supportable and one or more side walls extending between the lower and upper ends in which the access opening is defined, and wherein the food receiving member is rotatably supported on a support member at or near the lower end of the hollow body such that the food receiving member is rotatable relative to the hollow body.

6. The pizza oven accessory according to claim 1, wherein the hollow body includes a lower end supportable on the fuel receiving base of the barbecue, an upper end on which the lid of the barbecue is supportable and one or more side walls extending between the lower and upper ends in which the access opening is defined, and wherein the food receiving member is rotatably supported on a support member at or near the lower end of the hollow body such that the food receiving member is rotatable relative to the hollow body and the support member is offset from a central axis extending through the lower and upper ends of the hollow body such that the food receiving member is located within the hollow body nearer a side wall or portion thereof defining the access opening than to an opposite side wall or portion thereof.

7. The pizza oven accessory according to claim 1, wherein the hollow body includes a lower end supportable on the fuel receiving base of the barbecue, an upper end on which the lid of the barbecue is supportable and one or more side walls extending between the lower and upper ends in which the access opening is defined, and wherein an upper surface of the food receiving member is aligned with a bottom edge of the access opening defined in the hollow body.

8. The pizza oven accessory according to claim 1, wherein the food receiving member is round in shape.

9. The pizza oven accessory according to claim 1, wherein the food receiving member is a pizza stone, the pizza stone being rotatable on a rotating wheel rotatably mounted on a support member at or near the lower end of the hollow body such that the food receiving member is rotatable relative to the hollow body, thereby enabling in use the food to be rotated during cooking so as to cook the food evenly.

10. The pizza oven accessory according to claim 1, wherein the food receiving member is rotatably supported on a support member at or near the lower end of the hollow body such that the food receiving member is rotatable relative to the hollow body and further including a guard mounted on the support member and within the hollow body, the guard being operable to prevent food introduced into the pizza oven from falling off the food receiving member.

11. A pizza oven accessory according to claim 1, wherein the food receiving member is rotatably supported on a support member at or near the lower end of the hollow body such that the food receiving member is rotatable relative to the hollow body and further including a guard mounted on the support member and within the hollow body, the guard being operable to prevent food introduced into the pizza oven from falling off the food receiving member, and wherein the guard extends higher than the upper surface of the food receiving member, runs closely along at least a portion of a periphery of the food receiving member and is located in the hollow body nearer a side wall or portion thereof than opposite a side wall or portion thereof defining the access opening.

12. The pizza oven accessory according to claim 1, wherein the food receiving member is rotatably supported on a support member at or near the lower end of the hollow body such that the food receiving member is rotatable relative to the hollow body, and wherein the support member is supportable within the hollow body on corresponding support formations located within the hollow body.

13. The pizza oven accessory according to claim 1, wherein the food receiving member is rotatably supported on a support member at or near the lower end of the hollow body such that the food receiving member is rotatable relative to the hollow body, and wherein the support member is fastenable to the hollow body.

14. The pizza oven accessory according to claim 1, wherein the food receiving member is rotatably supported on a support member at or near the lower end of the hollow body such that the food receiving member is rotatable relative to the hollow body, and wherein the support member is fixed to the hollow body.

15. The pizza oven accessory according to claim 1 wherein the food is pizza.

16. A barbecue including a fuel receiving base, a lid and a pizza oven accessory for a barbecue, the pizza oven accessory including a hollow body receivable between a fuel receiving base and a lid of the barbecue operable to define a cooking chamber within the hollow body and between the base and lid of the barbecue, the hollow body further defining an access opening through which food is introducible or removable from the cooking chamber; and a food receiving member on which the food is receivable, the food receiving member being rotatably supported within or in close proximity with the hollow body.

17. (canceled)

18. (canceled)
